(19) United States
(12) Patent Application Publication
(10) Pub. No.: US 2008/0141828 A1
(43) Pub. Date: Jun. 19, 2008

(54) Method and Apparatus for Processing Metalline Sludge

(75) Inventors: Kai Judin, Alaviirre (FI); Yrjo Oinonen, Kokkola (FI)

Correspondence Address: MERCHANT & GOULD PC, P.O. BOX 2903, MINNEAPOLIS, MN, 55402-0903, US

(73) Assignee: Outokumpu Technology Oy, Espoo (FI)

(21) Appl. No.: 10/566,814

(22) PCT Filed: Jul. 22, 2004
(86) PCT No.: PCT/FI2004/000461

§ 371 Date: Aug. 30, 2007

(30) Foreign Application Priority Data
Jul. 31, 2003 (FI) 20031118

(51) Int. Cl. C22B 5/00; B03B 5/34

(52) U.S. Cl. 75/392; 209/725; 266/161

(57) ABSTRACT

The invention relates to a method for processing a metal-bearing sludge in conjunction with a metal separation process. According to the invention, the sludge (13) produced in the metal separation is classified based on a predetermined property of the sludge into a better (15) and a worse (17) substance fraction, as the process is concerned, and the worse substance fraction (17) is removed from the process and the better substance fraction (15) is returned to the process.

### FIELD OF THE INVENTION

The invention relates to a method as defined in the preamble of claim 1 and an apparatus as defined in the preamble of claim 13 for processing a metal-bearing sludge in conjunction with metal separation.

### BACKGROUND OF THE INVENTION

A sludge is herein used to mean a precipitate, a deposit, a solid matter-rich solution, etc. the dry matter content of which can vary from a nearly solution-like one to a solid one.

Known in prior art are many various metal separation processes for separating the desired metal from the other material e.g. in conjunction with metal manufacturing or metal recycling. In metal separation, the metal can be separated or removed from the material mixture. Metals can be separated by dissolving, precipitating e.g. with a suitable reagent, by forming compounds such as sulphides or oxides, electrolytically, by settling, filtering, distilling or extracting or in a corresponding manner. The separated metal can be in a solution-like, sludge-like or solid state. In several metal processing processes, metal-bearing sludge is formed as a result of separation. At least a part of this kind of sludge could be utilised. While in one fraction, the sludge cannot be utilised as well as possible, and no suitable methods are known for utilising a part of the sludge.

Known in prior art are various metal separation and metal removing methods in the field of metal manufacturing. Examples of separation methods that are performed in a solution phase include precipitation methods of copper, cobalt and nickel in conjunction with zinc preparation. To improve the precipitation efficiency of the desired metal, the solution must contain, as an activator or crystallisation core, at least one metal compound, and often as a compound, also metal precipitated in the process, which compound can be preferably recycled in the metal manufacturing processes. The metal compounds in question activate the separation of metal and function as a solid matter surface for the metal to be precipitated. The precipitated end product or a property thereof in the precipitation solution can often be used to accelerate the precipitation rate of metal. The surfaces of the metal compound particles of the recycled, precipitated sludge must be purified in order that they can function as good activators in the process. However, there is a problem that the sludge particles usually circulate or linger in the metal separation processes so long that there are non-desired impurities deposited on their surfaces, passivating the sludge, or they are agglomerated, forming bigger complexes, which makes the mixing of the reactor more difficult. There is a problem that the recycled, precipitated sludge is in one fraction, whereby the amount of the so-called active part is small with respect to the total amount, and if the amount of the active part is increased, then the total amount of deposit is also increased, the increased amount of deposit slowing and hindering the precipitation reactions of metal. Furthermore, the problem with the prior-art processes is that the sludge settled on the surface of the precipitation reactor or concentrator is recycled as a underflow, whereby specifically the big particles, i.e. the more passive material, is recycled back to the process.

Specifically in cobalt removal, the sludge remains long in the precipitation reactor, whereby calcium sulphate starts to deposit on the surface of the sludge particles, while passivating the sludge particles and increasing their size.

### OBJECTIVE OF THE INVENTION

The objective of the invention is to eliminate the drawbacks referred to above. One specific objective of the invention is to disclose a new classification method and apparatus for dividing the sludge into a better fraction for recycling and a worse fraction for removal from the reactor, as the reaction is concerned. One further objective of the invention is to disclose a novel method and apparatus for enhancing and improving the metal separation process.

### SUMMARY OF THE INVENTION

The method and apparatus in accordance with the invention are characterised by what has been presented in the claims.

The invention is based on a method for processing a metal-bearing sludge in conjunction with a metal separation process. According to the invention, the sludge created in the metal separation is classified, as the process is concerned, into a better and a worse substance fraction based on a predetermined property of the sludge, and the worse substance fraction is removed from the process and the better substance fraction is returned back to the process.

The invention is based on the basic idea that from the sludge created in metal separation, the desired and non-desired fraction are separated by classifying, preferably using an apparatus based on the centrifugal force. The classification in accordance with the invention is performed for a sludge already separated, preferably precipitated. The amount and particle size of the solid matter to be recycled in a metal separation process is controlled and regulated by removing a big part of the non-desired passive fraction from the reactor and by returning a suitable amount of the desired fraction back to the process. At the same time there is an attempt to maintain and strengthen the surface active properties of the metal-bearing sludge to be recycled.

The invention enables one to recycle the desired active material in the process and to remove the non-desired, often passive, material from the process. The invention enables one to adjust the solid matter content of the reactor to be suitable from the stand-point of the process. Furthermore, it is possible to maintain and even improve the desired properties of the sludge.

In one embodiment, the solid matter content of the reactor preferably is 10-200 g/l, more preferably 30-100 g/l. In that case, a lot of active reaction surface is achieved that accelerates the precipitation and contributes to the reduction of the consumption of the zinc powder to be introduced.

In one embodiment of the invention, the sludge is settled in conjunction with the metal separation prior to the classification. The sludge can be a underflow of the metal separation reactor or a underflow of the concentrator.

In one preferred embodiment of the invention, the classification is based on the surface activity of the sludge particles. In one embodiment of the invention, the classification is performed based on the granular size of the sludge particles by dividing the sludge into a coarser and more fine-grained fraction. As presented above, in one embodiment, the surface activity preferably depends on the granular size, enabling one to perform the classification based on the granular size, although a good surface activity specifically is a desired property in the fraction to be recycled.

In one embodiment of the invention, the classification is performed using an apparatus based on the centrifugal force, e.g. a hydrocyclone or the like. In one embodiment, it is possible to use as the classifier a separator based on the centrifugal force, such as e.g. the Lakos separator by Lakos-Laval. In that case, it is possible to achieve a underflow into which the big particles introduced into the classifier become concentrated nearly completely.

In one embodiment of the invention, the underflow of the classifying apparatus is the worse fraction from the standpoint of the process. The underflow is removed from the process either completely, or the desired part of the underflow is removed. In one embodiment, the overflow is the better fraction from the standpoint of the process. The amount of the overflow and underflow can be regulated using process-technical changes. The classification limit size is determined beforehand, being preferably close to the basic particle size.

In an alternative embodiment, the underflow is the better fraction from the standpoint of the process and the overflow the worse fraction.

In one preferred embodiment of the invention, the worse fraction from the standpoint of the invention mainly consists of a coarse fraction, and the better fraction mainly consists of a fine fraction, which can, however, contain a small amount of coarse particles.

The embodiments of the invention enable one to achieve in the process the desired and correct solid matter content. The invention has the advantage that e.g. big particles can be removed from the process, because they usually make the mixing more difficult and are passive as the metal separation is concerned.

Alternatively, the classification can be based on settling based on the size and/or density, screening or the like.

The classification can be performed either in batches or continuously, partly depending on whether the sludge is removed from the metal separation reactor in batches or continuously.

Further, the invention relates to an apparatus for classifying a metal-bearing sludge in conjunction with a metal separation process including one or more metal separation reactors, a feeding device for introducing the raw material into the metal separation reactor and a junction line for removing the sludge created in the metal separation from the reactor. According to the invention, the apparatus includes a classification device which is arranged in conjunction with the pipe from the metal separation reactor and which is arranged for classifying the sludge based on a predetermined property into a better and worse sub-stance fraction from the standpoint of the process, and recycling means for returning the better substance fraction to the metal separation reactor, and means for removing the worse substance fraction from the reactor.

The apparatus in accordance with the invention is simple in respect of its structure, and thus advantageous to implement.

Furthermore, the invention relates to the use of a method and apparatus in accordance with the invention in a hydrometallurgic zinc preparation process in which zinc-bearing ore is preferably concentrated, roasted and dissolved in sulphuric acid. Besides zinc, also copper, cobalt, nickel and cadmium as well as germanium and antimony are released in the dissolution. These metals or semi-metals, i.e. impurities, are removed from the solution by reduction using zinc powder in a solution purification process. The separation of these metals can be performed by precipitating in one or more phases from a zinc-bearing solution. According to the invention, the precipitated metals are classified as desired, and the desired fraction is returned to the process to facilitate and improve the separation of metals. After the aforementioned metals have been separated, the zinc is electrolytically reduced from a zinc sulphate solution. In zinc preparation, the impurities must be removed from a zinc-bearing material to achieve a successful and efficient electrolysis to reduce zinc. Particularly the metal ions Co²⁺ and Ni²⁺ of the iron group promote the re-dissolving of zinc that stratifies in the electrolysis, resulting in a decrease of the efficiency of electric current.

In one preferred embodiment, the invention relates to the use of a method and apparatus in accordance with the invention in a cobalt removing process in conjunction with zinc preparation. In conjunction with a cobalt removing process it is possible to precipitate also e.g. nickel, germanium and antimony. In a cobalt removing process, preferably an activator such as e.g. arsenic oxide is used to promote the precipitation of metals from a zinc-bearing solution. For example, in the presence of arsenic, cobalt and nickel can be precipitated relatively fast, in about 1.5 hours, to form cobalt and nickel arsenic. Besides arsenic, the solution preferably contains residual copper and recycled, produced cobalt deposit, which improve and accelerate the precipitation of cobalt. The precipitated cobalt deposit is classified as presented in the invention, and the desired fraction is recycled in the process to improve the precipitation of cobalt.

The cobalt removing process can be a continuous one or of the batch type. There must be enough solid matter in the precipitation process on whose surface the impurities precipitate. The surface must be purified metallic copper, or copper, cobalt or nickel arsenic to improve and activate the precipitation. The impurities that precipitate on the surface of the particles, such as basic zinc sulphates and calcium sulphate, passivate the deposit and increase the particle size.

Alternatively, the method and apparatus in accordance with the invention can also be used for the separation and removal of other metals in the manufacturing, recycling of metals, and other metal separation processes.

### LIST OF FIGURES

In the following section, the invention will be described by means of detailed embodiments with reference to the accompanying drawings, in which

FIG. 1 is a block diagram illustrating a hydrometallurgic zinc preparation process; and

FIG. 2 is a diagram illustrating one apparatus embodiment in accordance with the invention in a cobalt removing process.

### DETAILED DESCRIPTION OF THE INVENTION

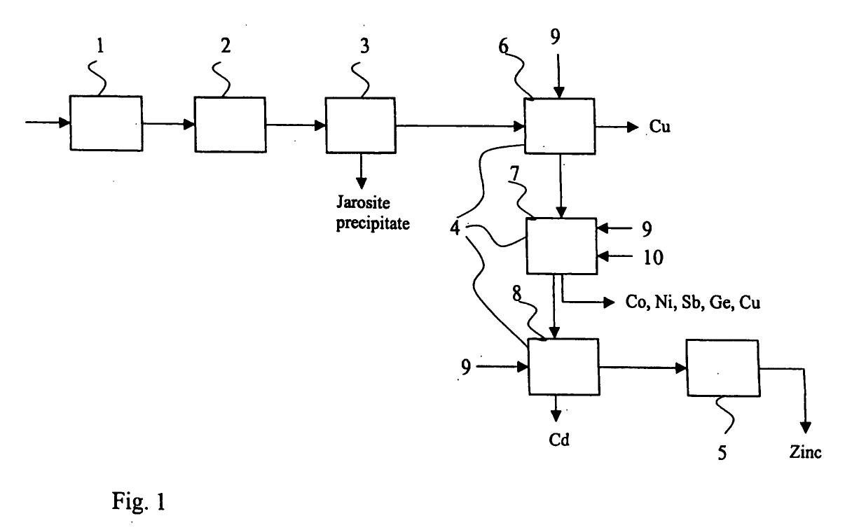

FIG. 1 shows a hydrometallurgical zinc preparation process. In a hydrometallurgical zinc preparation process, zinc ore is first concentrated 1, and the zinc concentrate is roasted 2. The purpose of the roasting 2 is to bring the sulphidic zinc into a soluble oxide form. After the roasting 2, the zinc roast is dissolved into sulphuric acid in one or more phases 3, whereby the zinc oxides react to form zinc sulphate. In a dissolution phase 3, iron is precipitated as a basic sulphate, i.e. as a jarosite precipitate. In a dissolution phase 3, the dissolved impurities, e.g. copper, cobalt, nickel, germanium, antimony and cadmium, are removed from the zinc sulphate solution in solution purification 4, which is preferably performed in three phases 6, 7, 8. In the first phase 6, the copper is removed by means of zinc dust 9. In the second phase 7, cobalt, nickel, germanium, antimony and the rest of the copper are removed from the solution by means of arsenic trioxide 10 and zinc dust 9 as metal arsenics, whereby zinc functions as a reducer. In the third phase 8, cadmium is removed by means of zinc dust 9. The purified zinc solution is introduced via cooling into electrolysis 5, wherein it is mixed with a circulating electrolyte. In the electrolysis 5, the zinc is reduced by means of cathodes. The roasting, dissolution and electrolysis are performed in a manner known per se in the field, so they are not described more fully herein.

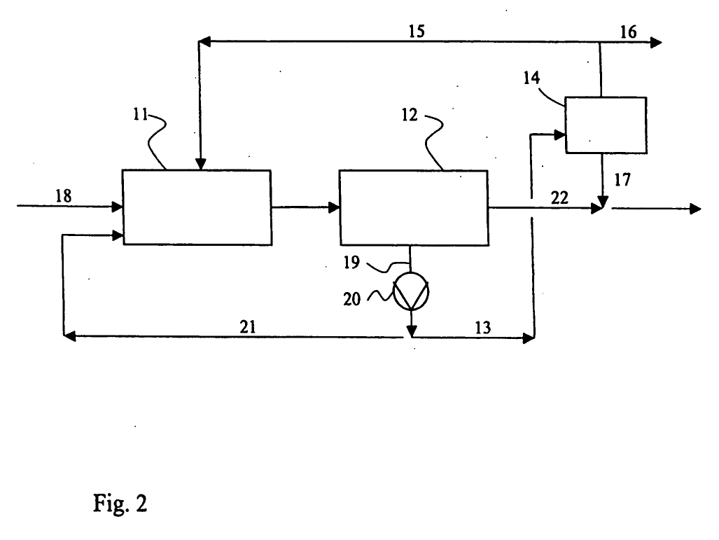

In the cobalt removal shown in FIG. 2, cobalt, nickel, germanium, antimony and residual copper are precipitated from the zinc sulphate solution 18 in many phases in reactors 11, 12, the capacity of which is e.g. 200-300 m³. The cobalt deposit 13 formed in the precipitation reactor 11 and/or 12 is classified using the classification device 14 in accordance with the invention, and the fraction 15 that is desired from the standpoint of the process is recycled back into the first reactor 11 of the process.

In the precipitation of cobalt, zinc powder, copper ions and preferably arsenic trioxides are used. Alternatively, instead of arsenic trioxide it is possible to use e.g. antimony trioxide or potassium antimony tartrate. The copper ions originate from the copper removing phase in which the residual copper is left in the zinc sulphate solution to function as a reagent for cobalt removal. The amount of residual copper to be left in the solution preferably ranges between 50-300 mg/l. The residual copper precipitates with arsenic as copper arsenic in the presence of the reducing action of zinc powder. The copper arsenic reacts in the solution with cobalt and nickel in the presence of zinc powder to form cobalt and nickel arsenic. The zinc powder and arsenic trioxide are introduced into the first cobalt removing reactor 11 by means of feeding devices known per se in the field. It is not preferred to use a big stoichiometric excess of zinc powder due to the creation of a non-desired side reaction; the excess of zinc does not thus add to the precipitation rate. Furthermore, in cobalt removal, the desired fraction 15 of precipitated cobalt deposit is recycled in cobalt removal, the desired fraction functioning in the reactor as a substance activating the reaction besides zinc powder and arsenic trioxide. In cobalt removal, the temperature and precipitation surface affect the precipitation rate. The precipitation surface is in practice dependant on the deposit content, although is not a linear function of it, owing at least partly to the purification degree of the surface of the particles in the deposit. A specific surface of a deposit is a prior-art way of roughly describing the absorption or absorption capability properties, i.e. the surface activity of a deposit. The precipitation rate can be increased by increasing the amount of deposit in the reactor and/or the quality of deposit, as well as by raising the temperature in the reactor.

In the precipitation reactor 11 and/or 12, the produced cobalt arsenic deposit is settled on the bottom of the reactor, from which it is introduced in batches or continuously as a underflow, via a junction line 12 and a pump 20, to a classification device 14, which in this embodiment is a Lakos separator of the hydrocyclone type. The cobalt arsenic deposit to be introduced into the classification device contains e.g. 150-200 g/l solid matter. By means of the classification device 14, the cobalt arsenic deposit 13 is divided, in batches, into a better 15 and a worse 17 fraction from the standpoint of the process based on the surface activity of the deposit particles. The better fraction 15 is obtained as an overflow of the classification device 14, and it contains mainly more fine-grained deposit particles and a few coarse particles. The worse fraction 17 is obtained as a underflow, and it contains mainly coarse deposit particles. The distribution and granular size of the overflow and underflow can be regulated as desired. The better fraction 15 is recycled mainly completely back to the cobalt precipitation 11. The cobalt deposit is recycled so that the solid matter content of the cobalt removal reactor(s) is about 10-200 g/l, preferably 30-100 g/l. If desired or necessary, a part 16 of the better fraction can be led out of the process. The worse fraction 17 is removed from the classification device 14 and process in batches. The removal density of the overflow can be regulated as desired.

Depending on the amount of the metals to be precipitated, the delay time of the better fraction of the cobalt deposit in the cobalt removing reactors can be about 1-2 months.

Alternatively, cobalt arsenic deposit can be lead in one fraction 21 back to the first reactor 11, or as an overflow 22 of the reactor out of the process, e.g. in conjunction with a process malfunction.

### EXAMPLE 1

In this test, fine-grained cobalt deposit, arsenic trioxide and zinc powder collected from the filter after the cobalt removal were roasted into the cobalt precipitation reactor. A supply in the form of zinc sulphate solution containing cobalt, nickel, germanium, antimony and residual copper (about 150 mg/l) from the copper removal phase was introduced into the reactor.

The metal impurities referred to above precipitated well, and the mixing of the reactor functioned well.

### EXAMPLE 2

In this test, cobalt deposit was introduced continuously from the cobalt removing reactor into the classification device with a flow of 18-20 m³/h. The solid matter content of the feed was about 150-200 g/l.

As an overflow of the classifying device, a sludge having a solid matter content of 1400 g/l was obtained. The flow of the overflow was 0.5-0.6 m²/h and mean granular size d(0.5) was 93.7 μm. The d(0.5) value of the overflow was 75.5 μm. The underflow contained particles smaller than 60 μm only about 3.5%, and the overflow contained particles smaller than 60 μm about 33%. Although the mean granular sizes of the overflow and underflow flows did not much differ from each other, the classification of a fine-grained material into an overflow was almost complete.

### EXAMPLE 3

In this test, cobalt deposit was introduced from a cobalt removing reactor other than in Example 2 continuously into the classification device with the flow of 18-20 m³/h. The solid matter content of the feed was about 150-200 g/l.

As a underflow of the classification device, a sludge having a solid matter content of 900 g/l was obtained. The flow of the underflow was 0.5-0.6 m³/h and mean granular size d(0.5) was 88.5 μm. The d(0.5) value of the overflow was 17.4 μm. The underflow contained particles smaller than 60 μm about 18%, and the overflow correspondingly about 93%. A underflow flow is, however, small compared to the flow of an overflow, whereby a main part of the fine-grained material is classified as an overflow.

### EXAMPLE 4

In this test, cobalt deposit was introduced from a cobalt removing reactor other than in Examples 2 and 3 continuously into the classification device with a flow of 18-20 m³/h. The solid matter content of the feed was about 150-200 g/l.

As a underflow of the classification device, a sludge having a solid matter content of 600-700 g/l was obtained. The flow of the underflow was 0.5-0.6 m³/h and mean granular size d(0.5) was 36.3 μm. The d(0.5) value of the overflow was 13.7 μm. The underflow contained particles smaller than 30 μm about 46%, and the overflow correspondingly about 86%. In this example, the cobalt deposit to be introduced was more fine-grained than in Examples 2 and 3.

The method and apparatus in accordance with the invention are applicable, in various embodiments, to the classification of various metal sludges in various processes.

The embodiments of the invention are not limited to the examples referred to above, instead they can vary in the scope of the accompanying claims.

1. A method for processing a metal-bearing sludge in cobalt removal that is performed in conjunction with zinc preparation process, wherein the sludge produced in the metal separation process is classified based on the surface activity of sludge particles into a better and worse substance fraction, as the process is concerned, and the worse fraction is removed from the process, and the better fraction is returned to the process.

2. The method as defined in claim 1, wherein the metal-bearing sludge is a product of a precipitation process.

3. The method as defined in claim 1 wherein the metal-bearing sludge is settled in a metal separation reactor prior to the classification.

4. The method as defined in claim 1, wherein the solid matter content in the reactor is adjusted to be in the range 10-200 g/l.

5. The method as defined in claim 1, wherein the classification is performed based on the granular size of the sludge particles by dividing the sludge into a coarser and finer fraction.

6. The method as defined in claim 1, wherein the classification is performed using a device based on the centrifugal force.

7. The method as defined in claim 6, wherein the classification is performed using a hydrocyclone or a similar device.

8. The method as defined in claim 1, wherein the underflow of the classification device is a worse fraction from the standpoint of the process.

9. The method as defined in claim 1, wherein the overflow of the classification device is a better fraction from the standpoint of the process.

10. The method as defined in claim 1, wherein the fraction that is worse from the standpoint of the process contains mainly coarse fraction.

11. The method as defined in claim 1, wherein the fraction that is better from the standpoint of the process contains mainly fine fraction.

12. The method as defined in claim 1, wherein the classification is performed in batches or continuously.

13. An apparatus for processing a metal-bearing sludge in cobalt removal that is performed in conjunction with zinc preparation process including one or more metal separation reactors, a feeding device for introducing raw material into the metal separation reactor and a junction line for removing the sludge produced in the metal separation from the reactor, wherein the apparatus includes a classification device which is arranged in conjunction with the pipe extending from the metal separation reactor and which is arranged for classifying the sludge based on the surface activity of sludge particles into a better and a worse substance fraction, as the process is concerned, and recycling means for returning the better substance fraction to the metal separation reactor, and means for removing the worse substance fraction from the reactor.

14. The apparatus as defined in claim 13, wherein the classification device is placed substantially in conjunction with the metal separation reactor for removing the sludge settled on the bottom from the bottom of the reactor.

15. The apparatus as defined in claim 13 wherein the classification device is based on the centrifugal force.

16. The apparatus as defined in claim 15, the classification device is a hydrocyclone or a similar device.

17. The apparatus as defined in claim 13, wherein the classification device is arranged to function in such a manner that the underflow of the device is the worse fraction from the standpoint of the process.

18. The apparatus as defined in claim 13, wherein the classification device is arranged to function in such a manner that the overflow of the device is the better fraction from the standpoint of the process.

19. The apparatus as defined in claim 13, wherein the classification device is arranged to function in batches continuously.

20-21. (canceled)
